(19) United States
(12) Patent Application Publication
(10) Pub. No.: US 2004/0234361 A1
(43) Pub. Date: Nov. 25, 2004

(54) Positioning device

(75) Inventors: Tsuyoshi Nakamura, Kanagawa (JP); Nobuhito Saji, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 10/805,214

(22) Filed: Mar. 22, 2004

(30) Foreign Application Priority Data
Apr. 14, 2003 (JP) P.2003-108559

(51) Int. Cl. B66C 17/08

(52) U.S. Cl. 414/217

(57) ABSTRACT

A positioning device capable of exhibiting an intrinsic function irrespective of the distortion of a surface plate and ensuring a maintenance facility. In case the clearance between an intermediate block and a moving blocks becomes improper, the lower wedge portions of adjusting support mechanisms are moved slide on abutment slopes with respect to upper wedge portions. As a result, the upper wedge portions are pushed up or down by the slopes of the lower wedge portions so that they can displace a sub-block up and-down while adjusting the extent of displacement finely at the unit of microns, for example. Therefore, the clearance between the intermediate block and the moving blocks can be set to a proper value thereby to retain the satisfactory actions of a differential pumping seal.

### BACKGROUND OF THE INVENTION

1. Field of the Invention

The present invention relates to a positioning device capable of moving a work in a chamber isolated from the external environment, for example.

2. Description of the Related Art

In a semiconductor manufacturing apparatus, a work is placed on a stage and is moved to be treated in a process chamber kept under vacuum or in a special gas atmosphere. When the positioning device is disposed in the process chamber, a lubricant to be supplied to a moving portion of the positioning device may splash to contaminate the inside of the process chamber.

Against this problem, a positioning device using a differential pumping seal is disclosed,in JP-A-2003-17546, for example. This positioning device of the related art is provided with: a casing including a guide face having an opening for communicating with the inside of the process chamber to be exposed to the vacuum; a moving block made movable at least in one direction while confronting the guide face through a predetermined clearance; and a differential pumping seal interposed between the casing and the moving block while enclosing the opening, for sealing between the inside of the process chamber and the outside of the process chamber under a higher pressure than that of the inside of the process chamber. The differential pumping seal exhausts the air from the small clearance formed between the casing and the moving block thereby to keep the atmosphere in the process chamber through the opening.

Here, the positioning device of the related art is placed on a rigid surface-plate (frame) The casing is made so highly rigid as to stand the vacuum so that the positioning device has a large weight of 2,000 Kg or more. At the action time of the positioning device, moreover, the center of gravity moves. This results in a problem that the surface plate (frame) is accordingly finely distorted. When the surface plate is finely distorted, the small clearance between the casing and the moving block varies so that the performance of the differential pumping seal varies or so that the casing and the moving block comes into direct contact with each other to obstruct their own relative movements. For these fears, it is conceivable to use a surface plate of a higher rigidity. However, another problem is that the area for the place is restricted or the cost for the place rises. In the case for the maintenance, on the other hand, the moving block may be isolated from the casing. In the related art, however, this isolation requires a large-scale disassembly including the pipings connected to the casing.

### SUMMARY OF THE INVENTION

In view of those problems of the related art, therefore, the invention has an object to provide a positioning device capable of exhibiting an intrinsic function irrespective of the distortion of a surface plate and ensuring a maintenance facility.

In order to achieve the above-specified object, according to the invention, there is provided a positioning device comprising; a casing having an opening and a process chamber kept in an environment different from the outside; a table arranged in the process chamber; a connecting portion connected to the table and extending through the opening to the outside; a moving portion connected to the connecting portion outside of the process chamber; a base for supporting the moving portion movably; a differential pumping seal arranged between the casing and the moving portion; and adjusting support mechanisms for supporting the base and the casing in a relatively displacing manner.

The positioning device of the device comprises: a casing having an opening and a process chamber kept in an environment different from the outside; a table arranged in the process chamber; a connecting portion connected to the table and extending through the opening to the outside; a moving portion connected to the connecting portion outside of the process chamber; a base for supporting the moving portion movably; a differential pumping seal arranged between the casing and the moving portion; and adjusting support mechanisms for supporting the base and the casing in a relatively displacing manner. Even in case the casing is distorted by its own weight when it is placed on the surface plate, therefore, the adjusting support mechanisms causes the relative displacement to hold t~he clearance between the base and the casing constant, so that the unexpected contact between the two can be prevented to keep the performance of the differential pumping seal best. In the case of the maintenance or the like, moreover, the base is disposed at a large distance from the casing so that the workability is enhanced.

Moreover, it is preferred that the casing is placed on a surface plate, and that the base is placed on the surface plate through the adjusting support mechanisms. The weight of the casing is not applied to the base so that the base is extremely hardly distorted. In case the opposed block for supporting the moving portion is supported by the base, for example, the distortion of the opposed block can be suppressed.

Moreover, it is preferred for a stable support that the base is supported at three points or more by the support portions of the adjusting support mechanisms.

Moreover, each of the adjusting support mechanisms includes: a first adjusting portion for displacing the base and the casing in a first extent relatively to each other; and a second adjusting portion for causing the displacement in a smaller extent than the first extent. At the maintenance time, the first adjusting portion is activated so tat an efficient maintenance can be done for a short time period. At the time of adjusting the clearance between the base and the casing finely, the second adjusting portion is activated so that a highly precise adjustment can be done.

Moreover, it is preferred that the adjusting support mechanisms include hydraulic type drive sources.

Moreover, it is preferred that the adjusting support, mechanisms include electric type drive sources.

Moreover, the adjusting support mechanisms include suppress means for suppressing the relative displacement of the base and the casing when no electric power is supplied. Then, the relative displacement can be suppressed while saving the energy.

Moreover, the casing includes a process chamber casing having a first opening for involving the process chamber, and a seal plate having a second opening and arranged between the process chamber casing and the moving portion, and the connecting portion extends through the first opening and the second opening. An O-ring or a bellows is so arranged between the process chamber casing and the seal plate as to enclose the first opening and the second opening. The atmosphere in the process chamber can be kept.

Here, the differential pumping seal has a function to discharge the gas in a small clearance between two opposed faces, for example, thereby to keep the atmospheres (e.g., an atmospheric pressure and a high vacuum) on the two sides across the opposed faces in a predetermined state while being in a noncontact state. A member having a discharge face will be called the “differential pumping seal” in the embodiments to be described hereinafter.

### BRIEF DESCRIPTION OF THE DRAWINGS

FIG. 1 is a sectional front elevation showing a positioning device 110 according to a first embodiment of the invention;

FIG. 2 is a section of the positioning device 110 of FIG. 1 cut in the direction of arrows II-II;

FIG. 3 is a section of the positioning device 110 of FIG. 2 cut in the direction of arrows III-III;

FIG. 4 a section of the positioning device 110 of FIG. 2 cut in the directions of arrows of IV-IV;

FIG. 5. a section of the positioning device 110 of FIG. 2 cut in the directions of arrows of V-V;

FIG. 6 a section of the positioning device 110 of FIG. 2 cut in the directions of arrows of VI-VI;

FIG. 7 is a sectional front elevation of a modification according to this embodiment;

FIG. 8 is a sectional front elevation similar to that of FIG. 1 but shows a second embodiment;

FIG. 9 is a section of the construction of FIG. 8 cut in the direction of arrows IX-IX;

FIGS. 10A and 10B are sections showing a portion X of the construction of FIG. 8 in an enlarged scale;

FIG. 11 is a sectional front elevation similar to FIG. 8 but shows a third embodiment; and

FIG. 12 is a section of the construction of FIG. 11 cut in the direction of arrow XII-XII.

### DESCRIPTION OF THE PREFERRED EMBODIMENTS

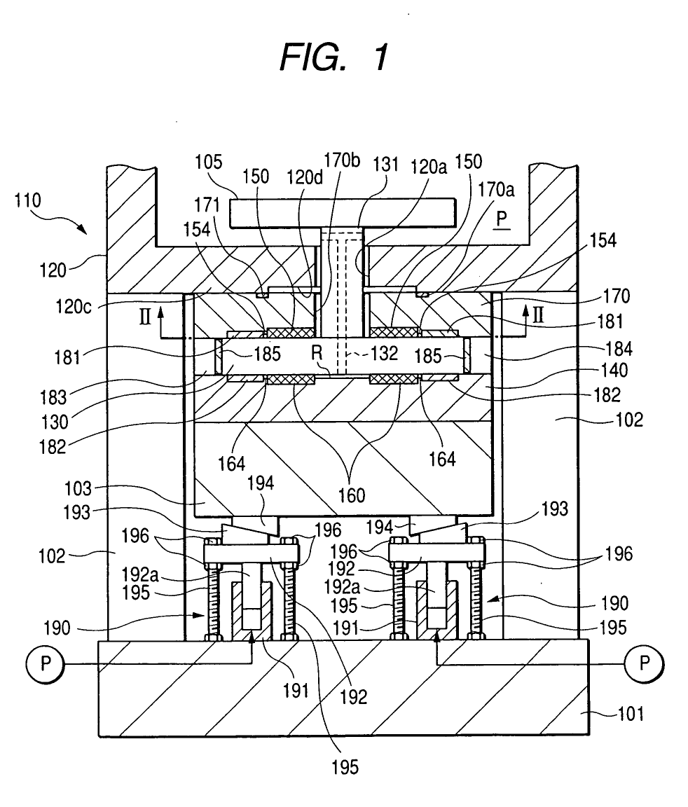

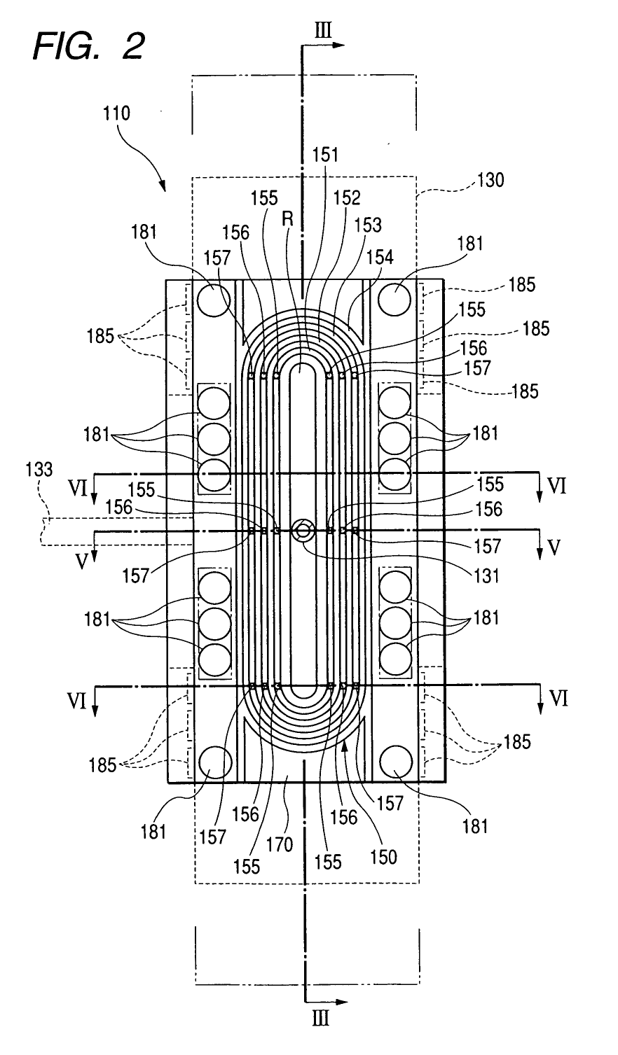

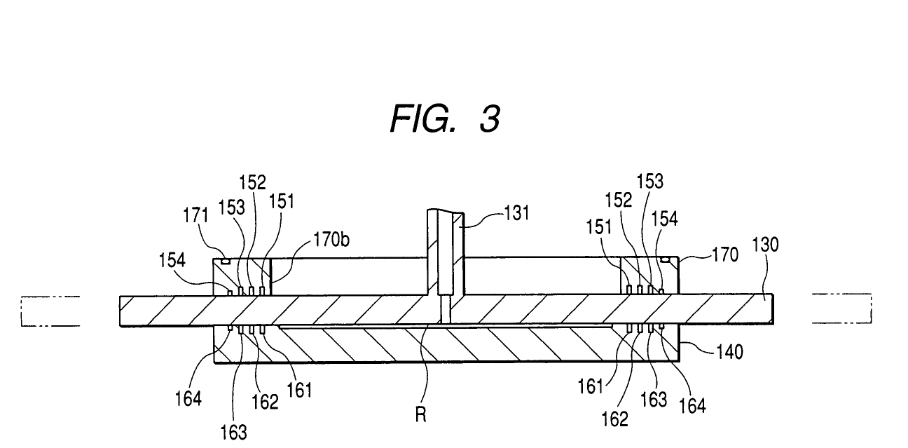

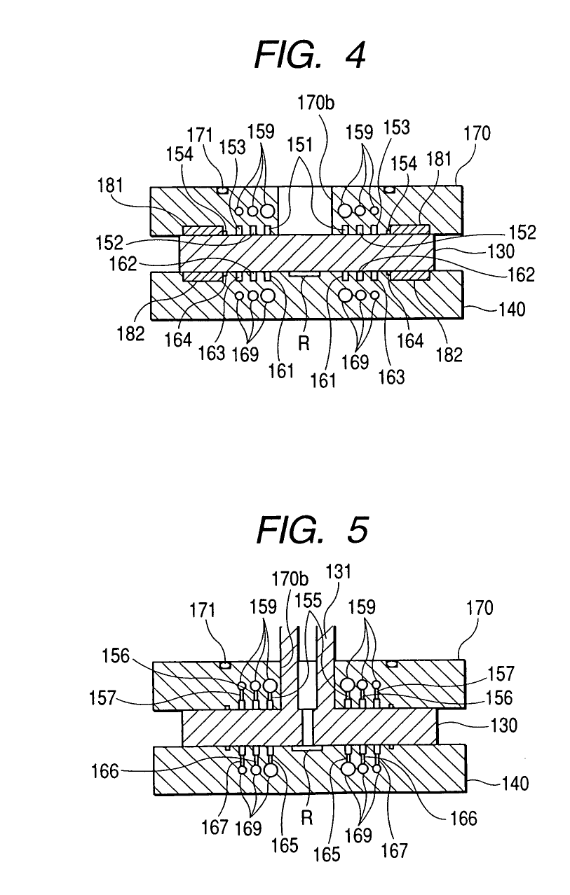

The preferred embodiments of the invention will be described with reference to the accompanying drawings. FIG. 1 is a sectional front elevation showing a positioning device 110 according to a first embodiment of the invention such that the upper portion of a sealed casing is omitted and such that a differential pumping seal and a hydrostatic gas bearing are simplified. FIG. 2 is a section of the positioning device 110 of FIG. 1 cut in the direction of arrows II-II. FIG. 3 is a section of the positioning device 110 of FIG. 2 cut in the direction of arrows III-III. FIGS. 4 to 6 are sections of the positioning device 110 of FIG. 2 cut in the directions of arrows of IV-IV, V-V and VI-VI, respectively.

As shown in FIG. 1, the positioning device 110 of this embodiment is constructed to include: a process chamber casing 120 having a process chamber P and an opening 120a for providing communication between the process chamber P and the outside; a moving block 130 arranged to confront the opening 120a of the process chamber casing 120; an intermediate block 170 (or a seal plate) sandwiched between the process chamber casing 120 and the moving block (or the moving portion) 130; an opposed block 140 arranged on the opposite side of the process chamber casing 120 (or the intermediate block 170) across the moving block 130; a light and highly rigid sub-block (or a base) 103 of ceramics; and three adjusting support mechanisms 190 placed on a surface plate 101 for supporting the sub-block 103 in a freely displacing manner. The process chamber P is evacuated to a vacuum through the not shown pipings by an external pump. The process chamber casing 120 is supported by four support legs 102 with respect to the surface plate 101. The process chamber casing 120 and the intermediate block 170 construct the casing.

In FIG. 1 and FIGS. 4 to 6, the upper faces of the two sides of the moving block 130 are supported through a predetermined clearance from the intermediate block 170 by hydrostatic gas bearings 181 (having their lower faces acting as a first guide face). The lower faces of the two sides of the moving block 130 are supported through a predetermined clearance from the opposed block 140 by hydrostatic gas bearings 182 (having their upper faces acting as a second guide face). The two side faces of the moving block 130 are supported by hydrostatic gas bearings 185 mounted in bearing blocks 183 and 184. Therefore, the moving block 130 can move in the direction normal to the sheet of FIG. 1 (or upward and downward of FIG. 2). Here in this embodiment, the hydrostatic gas bearings 181, 182 and 185 are individually made of generally cylindrical, porous graphite, and are so fixed that their bearing faces are made flush with the casing 140 or the bearing blocks 183 and 184. The hydrostatic gas bearings 181, 182 and 185 are fed with air via the not-shown air feed passages. The upper face of the moving block 130, as located adjacent to and on the inner side of the hydrostatic gas bearings 181, and the intermediate block 170 are sealed by a first differential pumping seal 150. The lower face of the moving block 130, as located adjacent to and on the inner side of the hydrostatic gas bearings 182, and the opposed block 140 are sealed by a second differential pumping seal 160. The hydrostatic gas bearings 181, 182 and 185 are enabled to support their opposed faces in a noncontact manner with the air which is pumped from the static pressure pump (although not shown) on the other hand, the differential pumping seals 150 and 160 are evacuated to a vacuum by the (not-shown) vacuum pump. Moreover, an annular space 154 (as will be detailed hereinafter) between the hydrostatic gas bearings 181 and the first differential pumping seal 150, and an annular space 164 (as will be detailed hereinafter) between the hydrostatic gas bearings 182 and the second differential pumping seal 160 are kept under the atmospheric pressure. The casing 120 supported on the surface plate 101 by the support legs 102 has the elliptical opening (or a first opening) 120a formed in its lower wall 120c. In FIG. 1, the lower wall 120c of the casing 120 is counter-sunk in its lower face to form a shallow elliptical counter-sunk portion 120d. In the upper face of the intermediate block 170 confronting the lower wall 120c, there is formed a grooved portion 170a along the periphery of the counter-sunk portion 120d. In the grooved portion 170a, there is arranged an O-ring 171 acting as distortion absorbing means. This O-ring 171 contacts against the lower face of the lower wall 120c of the casing 120 to seal the casing 120 and the intermediate block 170, Around the periphery of the outer side of the grooved portion 170a, too, there is formed a clearance, although not explicitly shown in FIG. 1, between the lower face of the lower wall 120c of the casing 120 and the upper face of the intermediate block 170. This peripheral clearance on the outer side has a size of about 0.1 mm and holds the upper face of the intermediate block 170 and the lower face of the lower wall 120c in a noncontact state.

The intermediate block 170 has an elliptical opening (or a second opening) 170b formed at its center. A connecting portion or a shaft 131 extends through the opening 170b and the opening 120a of the process chamber casing 120. The shaft 131 is provided for supporting a table 105 disposed in the process chamber P and is integrally attached to the upper face of the moving block 130. The opposed block 140, the moving block 130 and the second differential pumping seal 160 form a pressure-reducing chamber R together. A passage 132 extending through the shaft 131 provides communication between the process chamber P in the process chamber casing 120 and the pressure-reducing chamber R. A portion, at which the pressure-reducing chamber R confronts the lower face of the moving block 130, is an opening 140a. Here, the moving block 130 is connected to the not-shown drive unit through a connecting portion 133 (FIG. 2), The drive unit to be used can be exemplified by a combination of a motor and a feed screw such as a threaded screw, a combination of a motor, a belt and a pulley, or a linear motor. Moreover, the drive unit and the connecting portion 133 can also be omitted by providing an ultrasonic motor (although not shown) capable of driving the moving block 130 with respect to the opposed block 140 in place of or in addition to the hydrostatic gas bearings 185. In place of the connecting portion 133, still moreover, the moving block 130 may be provided at its longitudinal end portion with a connecting portion, through which the drive unit is connected. In this modification, it is preferred that the opening in the shorter direction of the moving block 130 is shielded.

The differential pumping seal 150 is composed of grooves 151, 152 and 153, communication holes 455, 156 and 157 and discharge holes 159. In FIG. 2, the four grooves 151 to 154 extend in a track shape along the elliptical hole 170b of the intermediate block 170. Of these, the groove 154 is extended tangentially to the two sides and is vented to the atmosphere at the two end faces of the intermediate block 170. As shown in FIGS. 2, 5 and 6, the communication holes 155 to 157 are formed from the bottoms of the grooves 151 to 153, respectively, to the inside of the intermediate block 170, and communicate with the six discharge holes 159, which extend longitudinally in the intermediate block 170, as shown in FIGS. 4 to 6. The discharge holes 159 are extended at their two ends to the outside of the intermediate block 170 and are individually connected to the not-shown vacuum pumps. It is, however, that the discharge holes 159 have the larger diameters toward the inside of the intermediate block 170 (i.e., the closer to the opening 170b), as shown in FIGS. 4 to 6.

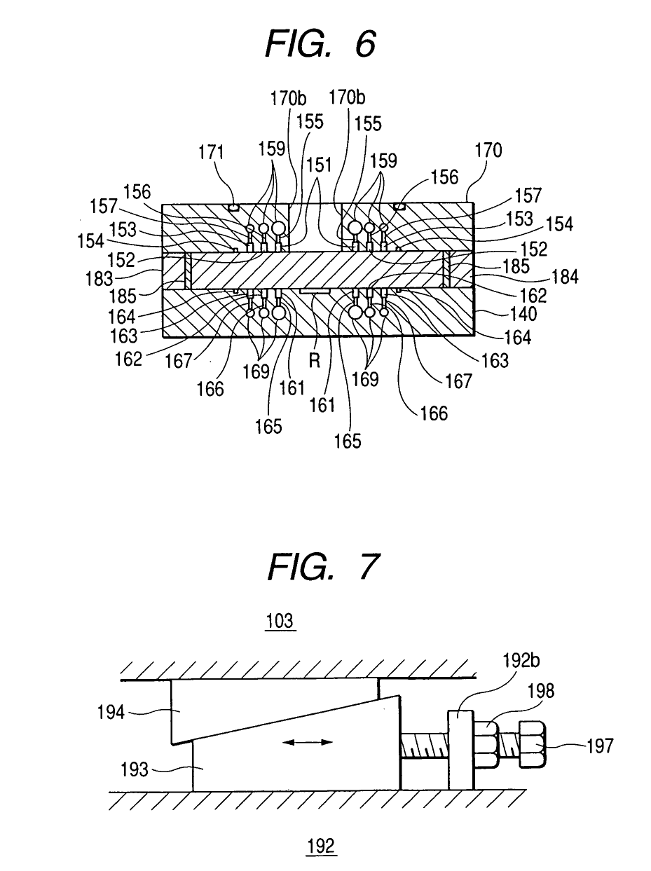

The differential pumping seal 160, which is opposed to the differential pumping seal 150 across the moving block 130 but has a similar construction, is composed of grooves 161, 162 and 163, communication holes 165, 166 and 167 and discharge holes 169. In FIG. 2, the four grooves 161 to 164 extend in a track shape along the elliptical pressure-reducing chamber R formed in the upper face of the opposed block 140. Of these, the groove 164 (or the annular space) is extended tangentially to the two sides and is vented to the atmosphere at the two end faces of the opposed block 140. As shown in FIGS. 5 and 6, the communication holes 165 to 167 are formed from the bottoms of the grooves 161 to 163, respectively, to the inside of the opposed block 140, and communicate with the six discharge holes 169, which extend longitudinally in the opposed block 140, as shown in FIGS. 4 to 6. The discharge holes 169 are extended at their two ends to the outside of the opposed block 140 and are individually connected to the not-shown vacuum pumps. It is, however, that the discharge holes 169 have the larger diameters toward the inside of the opposed block 140 (i.e., the closer to the pressure-reducing chamber R), as shown in FIGS. 4 to 6.

Each adjusting support mechanism 190 is composed of: a cylinder portion 191 placed on the surface plate 101; a support plate 192 having a piston portion 192a fitted in the cylinder portion 191; a lower wedge portion 193 held on the support plate 192 movably to the right and left of the Drawing; an upper wedge portion 194 fixed on the lower face of the sub-block 103 and having its slope abutting against the slope of the lower wedge portion 193; bolts 195 having their lower ends embedded in the surface plate 101 and their upper ends extending through the support plate 192; and lock nuts fastened on the bolts 195 for fixing the support plate 192. The cylinder portion 191 is connected through the simply shown piping to pumps P acting as the external liquid pressure drive sources. At the action time of the positioning device, the lock outs 196 are used to fix the support plate 192 on the bolts 195 so that the sub-block 103 may not be carelessly displaced. Here, the cylinder portion 191 and the piston portion 192a construct a first adjusting portion, and the lower wedge portion 193 and the upper wedge portion 194 construct a second adjusting portion. Moreover, three or more adjusting support mechanisms may be provided. In this modification, however, it is desired that the moving directions of the lower wedge portions 193 are concentrated at one point.

Here will be described the actions of the positioning device 110 according to this embodiment. The drive force of the not-shown drive source is transmitted through the connecting member 133 to the moving block 130 so that the shaft 131 is moved together. Therefore, the work (although not shown), which is carried on the table 105 mounted on the upper end of the shaft 131, can be positioned at an arbitrary position in the process chamber casing 120.

In case the process chamber casing 120 is under vacuum, its internal and external pressure difference is so large that the process chamber casing 120 is finely distorted accordingly. More specifically, the process chamber casing-120 is the least rigid in the vicinity of the opening 120a so that it is distorted to push the opening 120a upward, as shown in FIG. 1. In this embodiment, even when the central portion of the lower wall 120c of the process chamber casing 120 is moved upward by the distortion, the O-ring 171 acting as the distortion absorbing means does not leave the lower face of the lower wall 120c of the process chamber casing 120 so that the sealing performance between the process chamber casing 120 and the intermediate block 170 is retained. Specifically, the extent of distortion (which is insured by the fine clearance between the process chamber casing 120 and the intermediate block 170) of the process chamber casing 120 is estimated in advance and is set so that the O-ring 171 may be held in a state to contact with both the process chamber casing 120 and the intermediate block 170. In other words, as the process chamber P is evacuated so that the lower wall 120c of the process chamber casing 120 is warped and displaced upward, the extent of elastic distortion (or squeeze) of the O-ring 171 becomes smaller. However, the elastic distortion is made not to run short completely, even when it reaches the maximum extent estimated. More specifically, the process chamber casing 120 is supported on the surface plate 101 through the support legs 102. On the other hand, a guide mechanism for the intermediate block 170, the opposed block 140 and the moving block 130 composed of the bearing blocks 183 and 184 is also fixed with reference to the upper face of the surface plate 101. Therefore, the difference between the height of the support legs 102 and the height of the upper face of the intermediate block 170 is set to satisfy the aforementioned condition. By thus using the O-ring 171 as the distortion absorbing means, the simple construction having a small number of parts can be achieved to prevent the intermediate block 170, the opposed block 140 and the bearing blocks 183 and 184, as composing the guide mechanism for the moving block 130, from being adversely affected by the distortion of the process chamber casing 120.

In this embodiment, on the other hand, the pressure-reducing chamber: R of the opposed block 140 communicates with the process chamber P via the passage 132 so that its pressure is equalized to that in the process chamber P, As a result, the pressures on the upper and lower faces can be balanced to suppress the distortion of the center of the moving block 130. In this embodiment, moreover, the position of the O-ring 171 is substantially located between the differential pumping seal 150 and the hydrostatic gas bearings 182 (or the groove 154 vented to the atmosphere). In case the inside range of the groove 170a in the upper face of the intermediate block 170, as leading to the process chamber P, is evacuated, therefore, the opposite side of the intermediate block 170 provides the differential pumping seal 150 so that the intermediate block 170 can be effectively prevented from being distorted. Specifically, the pressure in the clearance at the portion of the differential pumping seal 150 between the intermediate block 170 and the moving block 130 is not equal to that in the process chamber P but can be sufficiently accepted as substantially equal. In the moving block 130, on the other hand, the differential pumping seals 150 and 160 and the hydrostatic gas bearings 181 and 182 are so well balanced on their upper and lower faces as to confront each other. Therefore, the forces to be received from those seals and bearings are balanced to eliminate the pressure difference between the upper and lower faces so that the moving block 130 is resultantly bent or distorted in the least. As a result, the clearance between the lower face of the intermediate block 170 and the upper face of the moving block 130 is kept substantially in the initial state so that the functions of the differential pumping seal 150 and the hydrostatic gas bearings 181 are not deteriorated. The clearance between the lower face of the moving block 130 and the upper face of the opposed block 140 is also kept substantially in the initial state so that the functions of the differential pumping seal 160 and the hydrostatic gas bearings 182 are not deteriorated either. Moreover, the load on the bearings is not caused by the pressure difference between the inside and the outside (under the atmosphere) of the process chamber P so that it does not fluctuate even if the pressure difference fluctuates.

Here, the load distribution on the surface plate 101 is not homogeneous, but its distortion mode is determined according to the surface plate rigidity, so that the extent of displacement of the support legs 102 is accordingly varied. However, the clearance for the optimum actions of the differential pumping seals 150 and 160 is about 5 to 10 microns. It is, therefore, desired for retaining smooth actions to consider the distortion of the surface plate 101.

In this embodiment, therefore, the following fine adjustment can be made in case the clearance between the intermediate block 170 and the moving block 130 becomes improper, for example.

FIG. 7 is a diagram showing a portion of the adjusting support mechanism of the construction of FIG. 1 in more detail. In FIG. 7, the lower wedge portion 193 is connected to a bolt 197, which is screwed in a support portion 192b mounted on the upper face of the support plate 192. As a result, the lower wedge portion 193 can be moved to slide on the abutment slope with respect to the upper wedge portion 194 by fastening and loosening the bolt 197 into and out of the support portion 192b. Therefore, the upper wedge portion 194 can be raised or lowered by the slope of the lower wedge portion 193 thereby to displace the sub-block 103 upward or downward while adjusting the displacement finely at the unit of microns, for example. After the bolt 197 was turned to a proper position, it is fixed on the support portion 192b by a lock nut 198 so that the bolt 197 and the lower wedge portion 193 are fixed. Here, the bolt 197 may also be turned by using the not-shown actuator.

At the time of maintenance or the like, the support plate 192 can be freely displaced with respect to the bolt 195 by loosening the locknut 196. When the valves (although not shown) in the pipings to the pumps P are opened, the liquid pressures in the cylinders 191 become lower so that the piston portions 192a are pushed into the cylinder portions 191 by the own weights of the sub-block 103 and so on. As a result, the sub-block 103, the opposed block 140 and the moving block 130 can be lowered. The extent of displacement of this case is far larger, for example, 200 mm or more than the adjustments of the wedge portions 193 and 194 so that the maintainability can be improved.

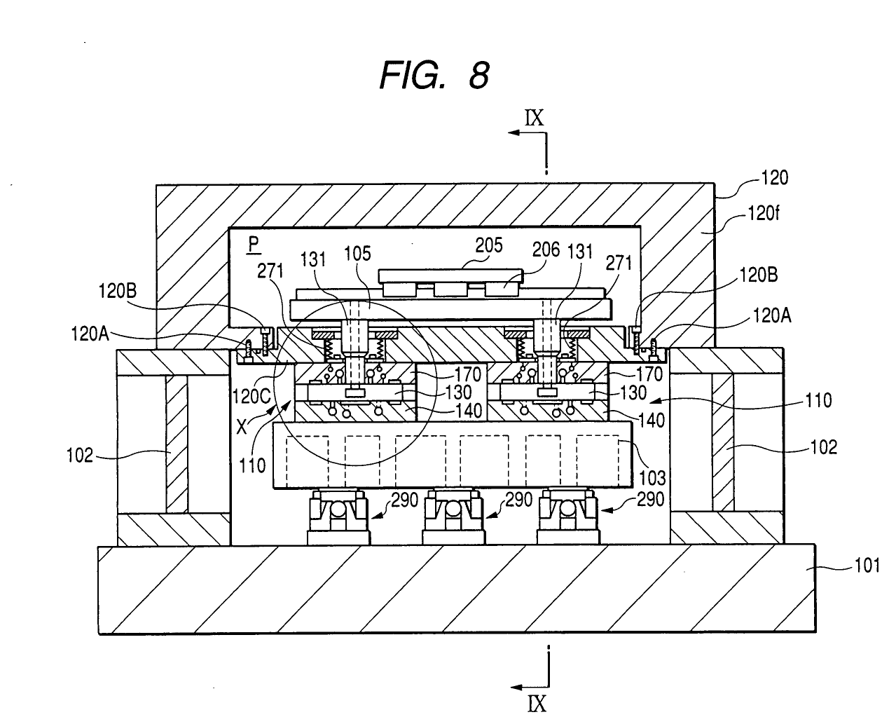

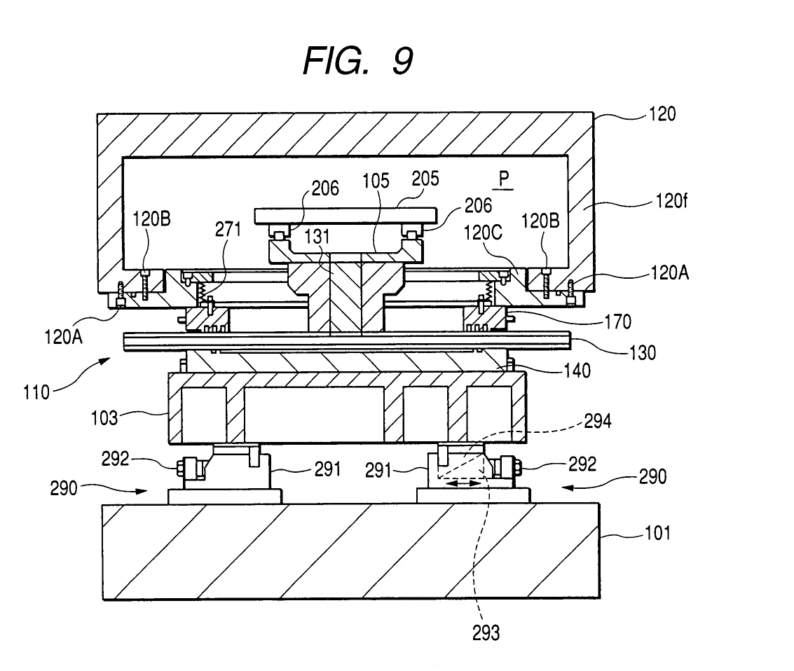

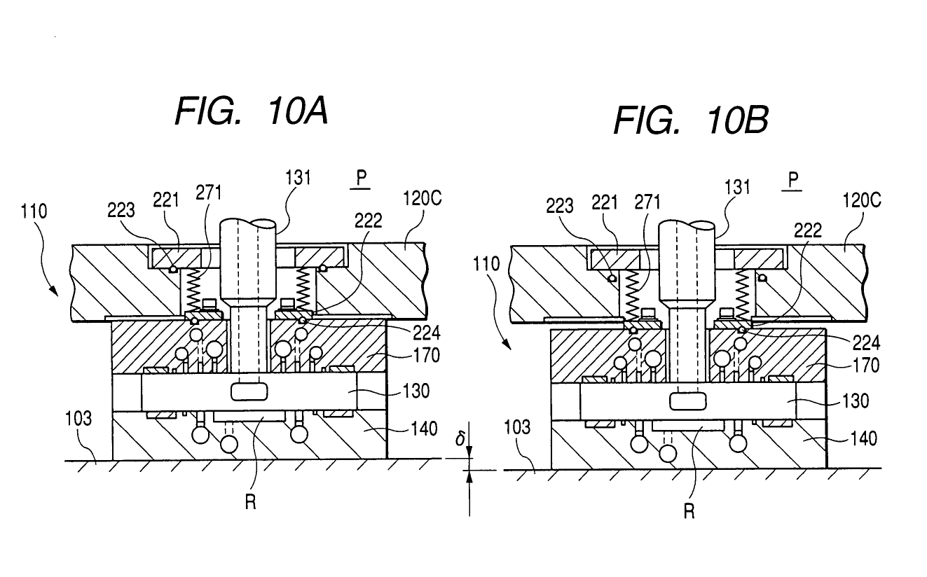

FIG. 8 is a sectional front elevation similar to that of FIG. 1 but shows a second embodiment, and FIG. 9 is a section of the construction of FIG. 8 cut in the direction of arrows IX-IX. FIGS. 10A and 10B are sections showing a portion X of the construction of FIG. 8 in an enlarged scale. In connection with this embodiment, the description will be made only on the portions different from those of the embodiment of FIGS. 1 to 6, and the description on the common portions will be omitted by designating them by the common reference numerals.

In FIG. 8, three adjusting support mechanisms 290 support the sub-block 103. The paired opposed blocks 140, the moving block 130 and the intermediate block 170 are arranged on the sub-block 103. The shafts 131 extending from the individual moving blocks 130 are connected at their upper ends to the single table 105. On this single table 105, there is so supported a sub-table 205 supported on a pair of linear guides 206 as to move to the right and left of FIG. 8 Here, the constructions and actions of the differential pumping seals and the hydrostatic gas bearings in this embodiment are similar to those of the embodiment shown in FIGS. 1 to 6.

In this embodiment, as shown in FIGS. 8 and 9, there are arranged the three adjusting support mechanisms 290 having identical constructions. Each of these constructions is made to include: a housing 291; an upper wedge portion 294 arranged in the housing 291 for-supporting the sub-block 103; a lower wedge portion 293 opposed in the housing 291 to the upper wedge portion 294 and made movable to the right and left in FIG. 9; and a hydraulic cylinder (which may also be exemplified by a linear actuator having a motor and a threaded screw mechanism) 292 for driving the lower wedge portion 293. The hydraulic cylinder 292 drives the lower wedge portion 293 so that the lower wedge portion 293 (as indicated by dotted lines) moves to slide on the abutment slope with respect to the upper wedge portion 294. The upper wedge portion 294 (as indicated by dotted lines) is raised or lowered by the slope of the lower wedge portion 293 so that it can displace the sub-block 103 upward or downward while adjusting the displacement finely at the unit of microns, for example.

In this embodiment, the lower face of the process chamber casing 120 and the upper face of the intermediate block 170 are connected by means of a metallic bellows 271. In FIGS. 10A and 10B, more specifically, an upper seal member 221 is so fixed in the lower wall 120c of the process chamber casing 120 as to enclose and the shaft 131 and seal it gas-tight with an O-ring 223. A lower seal member 222 is also so fixed in the upper face of the intermediate block 170 as to enclose the shaft 131 and seal it with the O-ring 223. The upper seal member 221 and the lower seal member 222 are connected by the bellows 271.

In case the gas-tightness between the lower face of the process chamber casing 120 and the upper face of the intermediate block 170 is retained with the O-ring, the gas-tightness may be degraded by the setting or the like of the O-ring due to the aging. This degradation in the gas-tightness can be confirmed by examining whether or not a helium gas exists in the vacuum process chamber P after the helium gas was blown to the vicinity of the O-ring, but this confirmation is troublesome. According to this embodiment, the gas-tightness can be retained over a long period by using the durable metallic bellows 271. Moreover, the metallic bellows 271 is advantageous in that it has a higher allowability for the dimensional errors than that of the O-ring. When the adjusting support mechanism 290 is activated, for example, as shown in FIGS. 10A and 10B, the vertical position of the sub-block 103 may vary within a range 6 Even in this case, the metallic bellows 271 can follow the variation to keep the gas-tightness. If the metallic bellows 271 is given the spring characteristics, moreover, it can apply a force to urge the center of the intermediate block 170, which is made of a thin metallic plate so that it has a considerable weight, upward. As a result, the clearance of the differential pumping seals between the intermediate block 170 and the moving blocks 130 can be kept proper to smoothen the actions of the positioning device 110.

Here, the process chamber casing 120 is connected at its upper portion 120f and its lower wall 120c by means of bolts 120A and 120B. When the sub-block 103 is lowered for the maintenance or work exchange, the upper portion 120f and the lower wall 120c of the process chamber casing 120 can be separated by loosening the bolts 120A and 120B. Here, the bolts 120B can be fastened or loosened by loosening the seal cover (although not shown) disposed on-the top face of the process chamber casing 120 and by inserting the tool into the space opened by the loosened seal cover.

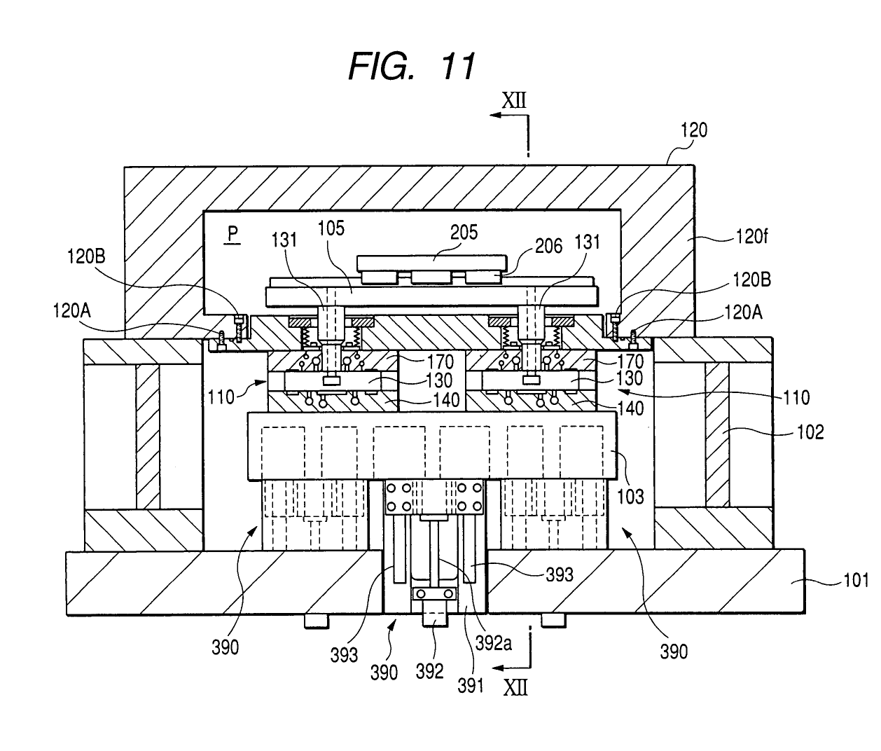

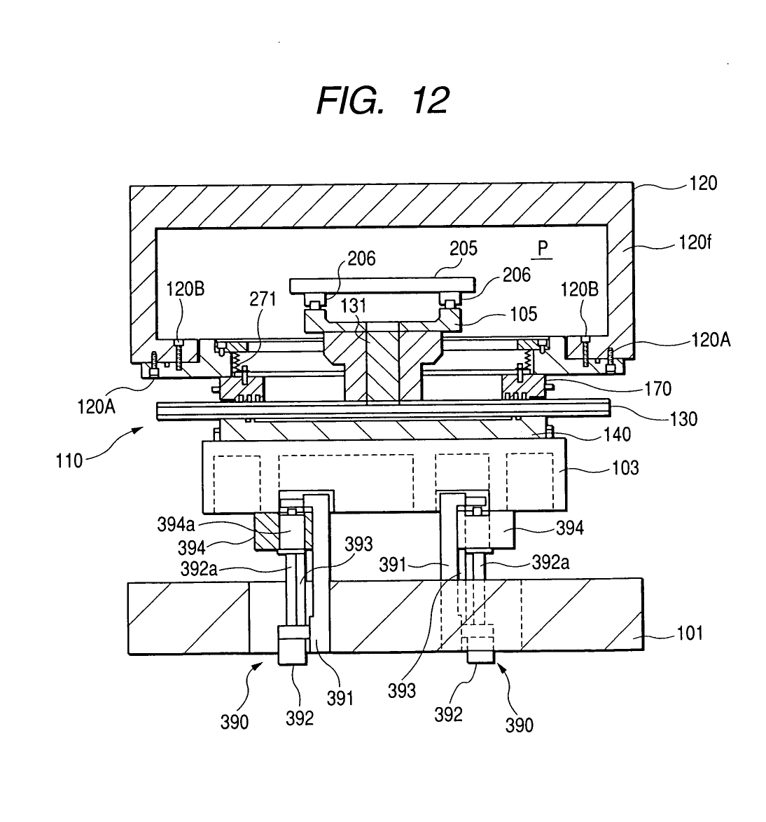

FIG. 11 is a sectional front elevation similar to FIG. 8 but shows a third embodiment, and FIG. 12 is a section of the construction of FIG. 11 cut in the direction of arrows XII-XII. In connection with this embodiment, the description will be made only on the portions different from those of the embodiment of FIGS. 8 to 10, and the description on the common portions will be omitted by designating them by the common reference numerals.

In FIG. 11, the sub-block 103 is supported by three adjusting support mechanisms 390. These adjusting support mechanisms 390 have identical constructions and are arranged such that two of them are opposed to one. Each of the adjusting support mechanisms 390 is constructed to include: a support plate 391 arranged on the sub-block 103; servomotors 392 mounted on the support plate 391 for turning square threads 392a; a pair of linear guides 393 extending in the direction to the upper limit, as shown; and moving portions 394 supported on the linear guides 393 and mounted on the lower face of the opposed block 140. The moving portions 394 have nuts 394a to be fastened on the square threads 392a.

According to this embodiment, when the servomotors 392 turns the square threads 392a, the nuts 394a move upward and downward of FIG. 11 so that the they can displace the sub-block 103 vertically while adjusting the extent of displacement finely at the unit of microns, for example. According to this embodiment, moreover, by adjusting the lead of the thread grooves, the weight of the opposed block 140 and so on can be supported by the frictional force to act between the square threads 392a and the nuts 394a, which construct suppress means. Even if the power supply to the servomotors 392 is interrupted, therefore, the opposed block 140 can be prevented from abruptly lowering thereby to save the energy.

The invention has been described hereinbefore in connection with its embodiments. However, the invention should not be so interpreted as to be limited to the embodiments, but can naturally be suitably modified/improved. For example, the grooves 151, 152 and 153 of the differential pumping seal 150 and the grooves 161, 162 and 163 of the differential pumping seal 160 are arranged in the three rows. However, the grooves should not be limited to that arrangement but may be arranged in two rows or in four rows or more according to the performance of the vacuum* pumps, the magnitude of the pressure difference between the inside and outside of the process chamber, and so on. On the other hand, the magnitude of the clearance between the process chamber casing 120 and the intermediate block 170 is determined according to the balance to the performance of the vacuum pumps and so on so that it can be suitably selected from several microns to several hundreds microns. Moreover, the bearings should not be limited to the linear guides or the hydrostatic gas bearings but can be exemplified by various bearings such as other roller bearings, e.g., cross roller guides. Still moreover, the individual extents of adjustment of a plurality of adjusting support mechanisms can be made different to cope with local distortions.

A positioning device of the invention comprises: a casing having an opening and a process chamber kept in an environment different from-the outside; a table arranged in the process chamber; a connecting portion connected to the table and extending through the opening to the outside; a moving portion connected to the connecting portion outside of the process chamber; a base for supporting the moving portion movably: a differential pumping seal arranged between the casing and the moving portion; and adjusting support mechanisms for supporting the base and the casing in a relatively displacing manner. Even in case the casing is distorted by its own weight when it is placed on the surface plate, therefore, the adjusting support mechanisms causes the relative displacement to hold the clearance between the base and the casing constant, so that the unexpected contact between the two can be prevented to keep the performance of the differential pumping seal best. In the case of the maintenance or the like, moreover, the base is disposed at a large distance from the casing so that the workability is enhanced.

What is claimed is:

1. A positioning device comprising:
a casing having an opening and a process chamber kept in an environment different from the outside;
a table arranged in said process chamber;
a connecting portion connected to said table and extending through said opening to the outside;
a moving portion connected to said connecting portion outside of said process chamber;,
a base for supporting said moving portion movably;
a differential pumping seal arranged between said casing and said moving portion; and,
adjusting support mechanisms for supporting said base and said casing in a relatively displacing manner.

2. A positioning device according-to claim 1,
wherein said casing is placed on a surface plate, and
wherein said base is placed on said surface plate through said adjusting support mechanisms.

3. A positioning device according to claim 2,
wherein said base is supported at three points or more by the support portions of said adjusting support mechanisms.

4. A positioning device according to claim 1,
wherein each of said adjusting support mechanisms includes: a first adjusting portion for displacing said base and said casing in a first extent relatively to each other; and a second adjusting portion for causing the displacement in a smaller extent than said first extent.

5. A positioning device according to claim 1,
wherein said adjusting support mechanisms include hydraulic type drive sources.

6. A positioning device according to claim 1,
wherein said adjusting support mechanisms include electric type drive sources-

7. A positioning device according to claim 6,
wherein said adjusting support mechanisms include suppress means for suppressing the relative displacement of said base and said casing when no electric power is supplied.

8. A positioning device according to claim 1,
wherein said casing includes a process chamber casing having a first opening for involving said process chamber; and a seal plate having a second opening and arranged between said process chamber casing and said moving portion,
wherein said connecting portion extends through said first opening and said second opening, and
wherein an O-ring or a bellows is so arranged between said process chamber casing and said seal plate as to enclose said first opening and said second opening.
